(19) United States
(12) Patent Application Publication
(10) Pub. No.: US 2008/0031684 A1
(43) Pub. Date: Feb. 7, 2008

(54) Component Provided With Bracket

(75) Inventor: Hideaki Matsunaga, Ibaraki (JP)

Correspondence Address: BACON & THOMAS, PLLC, 625 SLATERS LANE, FOURTH FLOOR, ALEXANDRIA, VA, 22314, US

(73) Assignee: Sanoh Industrial Co., Ltd., Ibaraki (JP)

(21) Appl. No.: 11/631,010

(22) PCT Filed: Jun. 3, 2005
(86) PCT No.: PCT/JP05/10638

§ 371 Date: Jul. 12, 2007

(30) Foreign Application Priority Data
Jul. 8, 2004 (JP) 2004-201346

(51) Int. Cl. F16L 41/00

(52) U.S. Cl. 403/187

(57) ABSTRACT

It is an object to provide a component provided with a bracket, in which soldering deficiencies seldom occur when soldering a bracket that has a bead to the component body, and moreover, in which plating liquid does not remain when plating is carried out. And in order to achieve this object, in a component provided with a bracket in which a bracket 2 having a bead 3 formed thereon is joined [to the component body 1] such that an end portion 3a of the bead 3 faces the component body 1, a hole 6 is provided penetrating the end portion 3a of the bead 3, and a cavity portion 7 defined by the bracket 2 and the component body 1 is made open to outside through the hole 6.

### TECHNICAL FIELD

The present invention relates to a component provided with a bracket, and more particularly to a component provided with a bracket suitable for joining the bracket and the component body by furnace soldering or carrying out plating on the bracket and the component body.

### BACKGROUND ART

In components such as the inflators employed in side air bags for example, the inflator housing is attached to the attachment target portion, such as a car body or a seat back, by way of a bracket.

In such cases, the end portion of the bracket is welded to the inflator housing as described in Japanese Patent Application Laid-open No. 2001-63511 for example. Moreover, beads are generally formed on such brackets for the purpose of reinforcing the brackets.

In this regard, as shown in FIG. 4, when a bracket 12 is joined to an inflator housing 11 by furnace soldering, due to air resistance or the like, the solder material sometimes does not flow into a cavity portion 14 that is formed by a peripheral surface of the inflator housing 11 and a concave portion of a bead 13 on the bracket 12, such that there is a risk of deficient soldering. Furthermore, in the case of carrying out plating, a plating liquid that enters the cavity portion 14 in a plating tank may remain inside the cavity portion 14 due to surface tension or the like even after [the work] is raised out of the plating tank, which poses a risk of corrosion if left as it is.

Accordingly, with the foregoing in view, it is an object of the present invention to provide a component provided with a bracket, in which soldering deficiencies seldom occur when soldering a bracket that has a bead to the component body, and moreover, in which plating liquid does not remain when plating is carried out.

### DISCLOSURE OF THE INVENTION

In order to solve the above-described problems, in the present invention, a component provided with a bracket in which the bracket, on which a bead is formed, is joined [to the component body] such that an end portion of the bead faces the component body is provided, wherein a hole is provided penetrating the end portion of the bead, and a cavity portion defined by the bracket and the component body is made open to outside through the hole.

Here, the shape of the component may be any shape, and the material may be any material.

With a component provided with a bracket according to the present invention, when the bracket is joined to the component body by soldering and when the soldering material enters a cavity portion formed by the component body and the bracket, the cavity portion is made open to the outside through the hole, and therefore the soldering material is not easily affected by resistance due to air and can easily enter the juncture portion between the component body and the bracket, thereby soldering can be performed stably. Furthermore, when a component, in which a bracket has been joined to the component body, undergoes plating, even if the plating liquid or the like enters the cavity portion, there is no risk that the plating liquid remains in the cavity portion since it is released outside from the hole formed at the end portion of the bead.

Consequently, it is possible to achieve a component provided with a bracket having good quality.

Furthermore, in the present invention, a width of the hole is formed not less than the inner width of the bead.

Here, the shape of the hole is not limited to a round shape and may be a shape that allows withdrawal of the curved portion of the end portion of the bead.

With a component provided with a bracket according to the present invention, the end portion of the cavity portion formed by the component body and the bead of the bracket is made completely open to the outside, and therefore the soldering material very reliably enters the juncture portion between the component body and the bracket when soldering is performed. Furthermore, when plating is performed, plating liquid that has entered the cavity portion does not remain there and is completely released to the outside.

Consequently, it is possible to achieve a component provided with a bracket having good quality.

Furthermore, in any of the above-mentioned aspects of the present invention, the bracket is joined to the component body by furnace soldering.

Here, the material of the component body and the bracket is limited to metals.

With a component provided with a bracket according to the present invention, the soldering material stably flows into the juncture portion between the component body and the bracket when the bracket is joined to the component body by furnace soldering, and therefore it is possible to achieve a component provided with a bracket having high bond strength.

Furthermore, in any of the above-mentioned aspects of the present invention, plating is carried out on the bracket and the component body.

Here, the material of the component body and the bracket is not limited to metals only, and may be a synthetic resin. Furthermore, the joining of the bracket to the component body is not limited to welding only, and may be achieved by an adhesive.

With a component provided with a bracket according to the present invention, plating liquid that has entered the cavity portion is released from the hole to the outside and does not remain in the cavity portion, a consequence of which it is possible to achieve a component provided with a bracket with no risk of corrosion and having high durability.

### BRIEF DESCRIPTION OF THE DRAWINGS

FIG. 1 is a perspective view schematically showing a portion of an inflator of a side air bag as a component provided with a bracket according to the present invention;

FIG. 2 is a cross-sectional view along a line A-A in FIG. 1;

FIGS. 3(a) and 3(b) show brackets as viewed from the rear, with FIG. 3(a) being a bracket on which two thin beads are formed and FIG. 3(b) being a bracket on which two thick beads are formed; and

FIG. 4 is a cross-sectional view of a component provided with a bracket of a conventional structure in which the bracket is joined to the inflator housing.

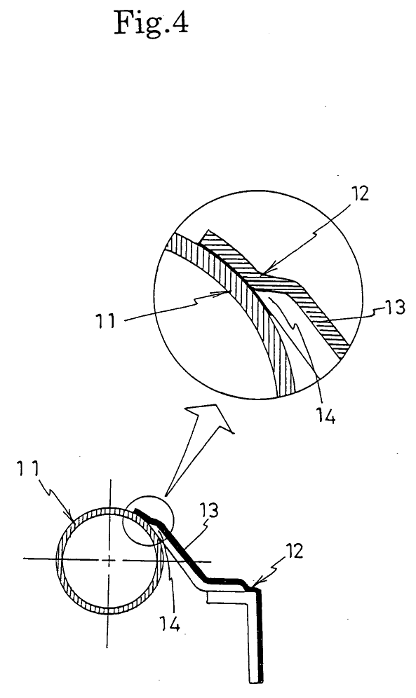

### BEST MODE FOR CARRYING OUT THE INVENTION

The following is a detailed description of the present invention using an inflator of a side air bag as an example of a component provided with a bracket, with reference to the accompanying drawings.

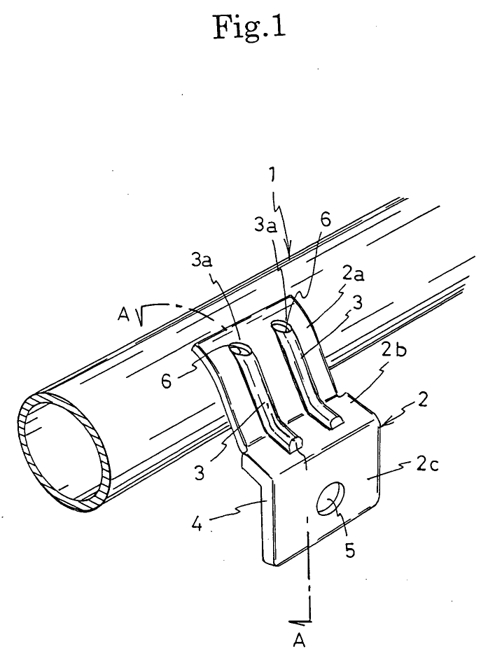

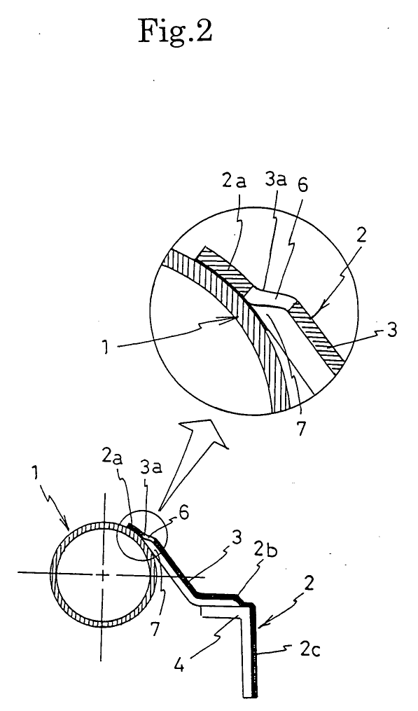

The inflator shown in FIGS. 1 and 2 is structured such that a bracket 2 is joined to a cylindrical inflator housing 1.

The bracket 2 is formed in a substantial crank-shape in a longitudinal direction and two beads 3 are formed spanning from an end portion 2a to an intermediate portion 2b. Furthermore, at the intermediate portion 2b and a base portion 2c of the bracket 2, flanges 4, 4 are formed facing inward from side portions thereof, and a hole 5 is formed at a central portion in the width direction of the base portion 2c, for attaching the bracket 2 to a car body or seat (not shown) or the like.

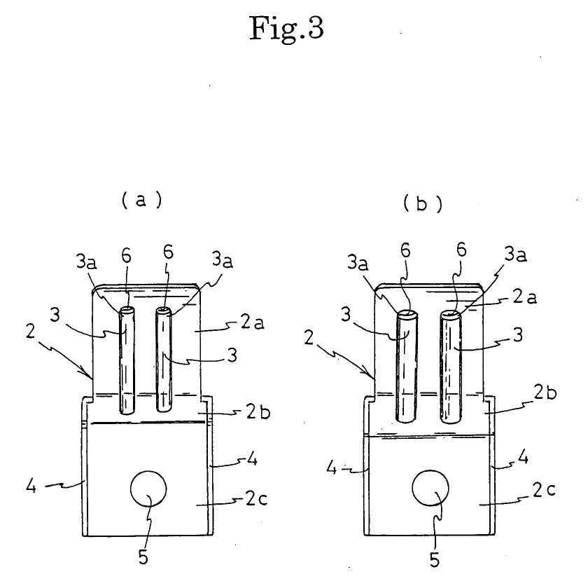

Furthermore, in the bracket 2, holes 6 are provided penetrating through end portions 3a of the beads 3. It is preferable that the holes 6 are formed so as to have a width not less than the inner width of the beads 3 as shown in FIGS. 3(a) and 3(b), but the shape thereof is not limited to a round shape, and may be a shape that allows withdrawal of the curved portion of the end portions 3a of the beads 3.

As shown in FIG. 2, the end portion 2a of the bracket 2 is brought into contact with the peripheral surface of the inflator housing 1 such that the end portions 3a of the beads 3 touch the peripheral surface thereof. In this state, [the bracket is] provisionally attached to the inflator housing 1 using resistance welding or TIG welding or the like, and then furnace soldering is carried out.

At this time, a soldering material enters a cavity portion 7 formed by the peripheral surface of the inflator housing 1 and an inner surface of the end portion 3a of the bead 3 of the bracket 2, and the soldering material flows into the entire juncture portion between the inflator housing 1 and the bracket 2 of the cavity portion 7, such that the juncture portion is uniformly joined.

Following this, the inflator housing 1 to which the bracket 2 is joined undergoes plating.

At this time, the plating liquid enters the cavity portion 7, but the plating liquid does not remain in the cavity portion 7 since it escapes outward from the holes 6.

In this way, the inflator housing 1, to which the bracket 2 is soldered and which undergoes plating, is fastened to a car body or a seat (not shown) or the like using a bolt (not shown) that inserts through the hole 5.

It should be noted that a component provided with a bracket, in which the bracket 2 was joined to the inflator housing 1, was shown in the abovementioned embodiment, but of course the structure of the present invention can be applied to components provided with other brackets.

### INDUSTRIAL APPLICABILITY

With a component provided with a bracket according to the present invention described above, soldering can be performed stably when the bracket is joined to the component body by soldering and, moreover, it is possible to achieve uniform plating without plating liquid remaining in the cavity portions of the beads when the component, to which the bracket has been joined, undergoes plating. For this reason, the present invention can be used for all components provided with a bracket, on which a bead is formed and which is joined to the component body such that an end portion of the bead faces the component.

1. A component comprising a bracket in which the bracket having beads formed thereon so as to reinforce the bracket is joined to a component body such that an end portion of said bead faces the component body, then the component and the jointed bracket are plated, characterized in that a hole is provided penetrating the end portion of said bead, and a cavity portion defined by said beads on said bracket and the component body is made open to outside through said hole.

2. The component comprising a bracket according to claim 1, characterized in that a width of said hole is formed not less than an inner width of said bead.

3. The component comprising a bracket according to claim 1, characterized in that said hole is formed so that the plating liquid can be easily released to the outside.

4. (canceled)
